(19) United States
(12) Patent Application Publication
(10) Pub. No.: US 2022/0078739 A1
(43) Pub. Date: Mar. 10, 2022

(54) METHOD TO VALIDATE TIMING ADVANCE FOR PRECONFIGURED RESOURCE TRANSMISSION

(71) Applicant: TELEFONAKTIEBOLAGET LM ERICSSON (PUBL), Stockholm (SE)

(72) Inventors: Chunhui ZHANG, STOCKHOLM (SE); Santhan THANGARASA, VÄLLINGBY (SE); Muhammad KAZMI, SUNDBYBERG (SE); Joakim AXMON, LIMHAMN (SE)

(21) Appl. No.: 17/424,273

(22) PCT Filed: Feb. 14, 2020
(86) PCT No.: PCT/IB2020/051277

§ 371 Date: Jul. 20, 2021

Related U.S. Application Data
(60) Provisional application No. 62/806,648, filed on Feb. 15, 2019.

(51) Int. Cl. H04W 56/00; H04B 17/318; H04W 72/04

(52) U.S. Cl. CPC H04W 56/0045; H04W 72/04; H04B 17/318

(57) ABSTRACT

A method performed by a wireless device for validating a timing advance (TA) value for use with an uplink transmission in a wireless communication network using a preconfigured resource is disclosed. The method comprises storing a TA value received from a base station and measuring a signal strength variation. The method further comprises comparing the measured signal strength variation with a first signal strength maximum variation threshold to determine whether the stored TA value is valid. Also disclosed are a method performed by a base station, a wireless device, a user equipment and a base station.

### TECHNICAL FIELD

The present application generally relates to wireless communication systems, and particularly relates to validating a timing advance (TA) value for an uplink transmission in preconfigured resources (PUR) in a wireless communication system.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Recent work in the 3rd Generation Partnership Project (3GPP) has led to the specification of technologies to cover Machine-to-Machine (M2M) and/or Internet of Things (IoT) related use cases. Most recent work for 3GPP Release 13 and 14 includes enhancements to support Machine-Type Communications (MTC) with new UE categories (Cat-M1, Cat-M2), supporting reduced bandwidth of 6 physical resource blocks (PRBs) (up to 24 PRBs for Cat-M2), and Narrowband IoT (NB-IoT) UEs providing a new radio interface (and UE categories, Cat-NB1 and Cat-NB2).

LTE enhancements introduced in 3GPP Release 13, 14 and 15 for MTC are referred to herein as “eMTC”, including (not limited to) support for bandwidth limited UEs, Cat-M1, and support for coverage enhancements. This is to distinguish from NB-IoT (notation here used for any Release), although the supported features are similar on a general level.

It is important to improve the uplink transmission efficiency and/or UE power consumption so the MTC device can support more densified deployment and provide longer battery life. In 3GPP, support for transmission in preconfigured resources in idle and/or connected mode based on SC-FDMA waveform for UEs with a valid timing advance is a feature to further optimize the uplink transmission efficiency.

In a 3GPP LTE Release 16 work item on NB-IoT and eMTC enhancements a new feature called transmission in preconfigured resources (PUR) in idle and/or connected mode, is being introduced. The UE is allocated with PUR resources during RRC connected state and is also assigned a TA value by the serving cell. The PUR resources can be of different types, namely dedicated, contention-free shared or contention-based shared PUR resource. A PUR resource is defined as a physical channel resource e.g. PUSCH resource, i.e. it is a resource allocated in both time- and frequency domain. In the case of NB-IoT, PUR resource is same as the NPUSCH resource. For cat-M, it is the same as a PUSCH resource comprising 6 PRBs (e.g. for UE category M1) or 24 RBs (e.g. for UE category M2). Analogous to PUSCH and NPUSCH, the repetitions can also be used for PUR transmissions, which is especially the case when operating under extended coverage.

The UE uses the preconfigured TA value when transmitting using the PUR resources in idle state provided the serving cell does not change. If the serving cell changes then the PUR resources and TA value from the old serving cell become invalid. In addition, the UE can also be configured to check the validity of the TA value based on the changes in the RSRP in MTC or NRSRP in NB-IoT. The UE is allowed to transmit using PUR only if the preconfigured TA value is valid. For example, if the magnitude of the difference between the measured RSRP at the time of transmission using PUR and the measured RSRP when the TA value was configured is below certain threshold, then the UE assumes that the preconfigured TA value is valid. If the TA value is valid then the UE is allowed to use the PUR resources for transmission; otherwise the UE should not carryout transmission using PUR.

RSRP estimation accuracy is specified not more than +/−7 dB which means estimated RSRP value could vary so long as it meet the measurement accuracy requirement. The RSRP estimation error depends on the measurement period over which certain number of the samples are averaged and the side condition (e.g. SINR) in terms of the received signal to noise ratio. For example, the current RSRP measurement accuracy is +/−7 dB in normal condition. So even if the UE does not move and radio condition does not change, there could be +/−7 dB fluctuation in RSRP compared to the ideal RSRP.

The timing advance (i.e. TA value) configured by the serving network node (e.g. BS) translates into how far the UE is located with respect to the serving BS. The timing advance is used by the UE when transmitting signals and it ensures that transmissions by all the UEs within the cell can arrive at the base station at the same time or at least within certain time e.g. within the cyclic prefix. The TA value hence is related to propagation delay and therefor to the distance between the UE and the BS.

The RSRP is a measure of the received signal strength, therefore the path loss between the BS and UE will affect the RSRP.

The UE is allowed to use preconfigured resources for uplink transmission in idle state provided that the signal strength (e.g. RSRP, NRSRP) does not change by certain margin. It is assumed that if this condition is met (e.g. RSRP does not change outside a certain margin) then the TA value configured at the UE is valid for transmitting the preconfigured resources. However, the relation between the change in RSRP and change in the propagation delay (hence in optimal timing advance to use) when the UE changes its position is not straight forward e.g. it is not linear relation. Therefore a mechanism is needed to ensure that the UE does not transmit in preconfigured resources in situations when the BS is unable to receive the UE signals.

### SUMMARY

These and other problems are generally solved or circumvented, and technical advantages are generally achieved, by advantageous embodiments of the present disclosure for a system and method for validating a timing advance (TA) value for use with an uplink transmission using a preconfigured resource.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. A first general aspect includes a method in which a wireless device validates a timing advance (TA) value for use with an uplink transmission in a wireless communication network using a preconfigured resource. The method includes storing a TA value received from a base station, measuring a signal strength variation, and comparing the measured signal strength variation with a first signal strength maximum variation threshold to determine whether the stored TA value is valid. Other embodiments of this aspect include corresponding computer systems, apparatus, and computer programs recorded on one or more computer storage devices, each configured to perform the actions of the methods.

Implementations may include one or more additional features. For example, the first signal strength maximum variation threshold may vary according to the stored TA value.

The method may also include comparing a second signal strength maximum variation threshold with a reference level and determining that the stored TA value is invalid when the second signal strength maximum variation threshold is less than the reference level. The first signal strength maximum variation threshold may be defined as the second signal strength maximum variation threshold plus the reference level.

The method may further include transmitting a message to the base station using a preconfigured resource and the stored TA value when the stored TA value is determined to be valid. The method may be performed when the wireless device is configured in an idle mode and the message is transmitted using the preconfigured resource. The method may further include determining that the stored TA value is valid when the measured signal strength variation is less than the first signal strength maximum variation threshold. According to one aspect, measuring the measured signal strength variation includes: obtaining a current signal strength measurement, and calculating a difference between the current signal strength measurement and a signal strength measurement obtained at a time the stored TA value was received from the base station.

The method may also include receiving an indication of one or more preconfigured resource transmission occasions from the base station. The first signal strength maximum variation threshold may vary according to the stored TA value in accordance with a mapping that associates a plurality of TA values with corresponding signal strength maximum variation thresholds using one or more of: a table, a function, and one or more conditional expressions. The mapping may be one of: at least partially pre-defined, at least partially configured by the network, and/or at least partially determined autonomously by the wireless device. The signal strength maximum variation threshold may be an RSRP maximum variation threshold. The first signal strength maximum variation threshold may be obtained using one or more of: a cyclix prefix length of a configured frame structure, a network-configured time advance allowed error, the stored TA value, a distance between the wireless device and the base station at a time the TA value is received, an allowed distance change accuracy determined on the basis of the cyclic prefix length and/or the network-configured time advance allowed error, a network-configured allowed distance change accuracy, and a pathloss model to derive the signal change. The first signal strength maximum variation threshold may be configured in the wireless device by the wireless communication network. Implementations of the described techniques may include hardware, a method or process, or computer software on a computer-accessible medium.

A second general aspect includes a method performed by a base station for facilitating validating a TA value for use with an uplink transmission from a wireless device using a preconfigured resource. The method includes receiving a random access request from the wireless device, estimating a TA value based on the random access request, sending the TA value to the wireless device, determining a signal strength maximum variation threshold for the wireless device to compare with a measured signal strength variation, and sending the signal strength maximum variation threshold to the wireless device to facilitate validation of the TA value by the wireless device. Other embodiments of this aspect include corresponding computer systems, apparatus, and computer programs recorded on one or more computer storage devices, each configured to perform the actions of the methods.

A third general aspect includes a method performed by a base station for facilitating validating a ta value for use with an uplink transmission from a wireless device using a preconfigured resource. The method includes: receiving a random access request from the wireless device; estimating a TA value based on the random access request, obtaining a signal strength maximum variation threshold based on the TA value; and determining, on the basis of the signal strength maximum variation threshold, whether to configure the wireless device to use a TA validation technique that depends on signal strength measurements when transmitting using the preconfigured resource. Other embodiments of this aspect include corresponding computer systems, apparatus, and computer programs recorded on one or more computer storage devices, each configured to perform the actions of the methods.

The methods described herein may, in certain embodiments, help avoid or at least reduce incorrect decisions being made by the wireless device when validating the TA for a PUR transmission. In addition, interference in the serving and neighboring cells may be reduced since unnecessary wireless device transmissions are avoided. Moreover, reception of signals from the wireless device using PUR transmission at the base station receiver may be enhanced by application of the methods described herein. Furthermore, each of the foregoing embodiments may be embodied as a method or as an apparatus configured to perform the method.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, reference is now made to the following descriptions taken in conjunction with the accompanying drawings, in which:

FIG. 1 illustrates a wireless network in accordance with some embodiments;

FIG. 2 illustrates an example User Equipment (UE) in accordance with some embodiments:

FIG. 3 is illustrates a virtualization environment in accordance with some embodiments;

FIG. 4 is illustrates an example telecommunications network connected via an intermediate network to a host computer in accordance with some embodiments;

FIG. 5 illustrates an example host computer communicating via a base station with a user equipment over a partially wireless connection in accordance with some embodiments;

FIG. 6 is a flow diagram of an example method implemented in a communication system including a host computer, a base station and a user equipment in accordance with some embodiments;

FIG. 7 is a flow diagram of another example method implemented in a communication system including a host computer, a base station and a user equipment in accordance with some embodiments;

FIG. 8 is a flow diagram of another example method implemented in a communication system including a host computer, a base station and a user equipment in accordance with some embodiments;

FIG. 9 is a flow diagram of another example method implemented in a communication system including a host computer, a base station and a user equipment in accordance with some embodiments;

FIGS. 10A-10B depict a flowchart illustrating a method of operating a wireless device;

FIG. 11 is a flowchart illustrating a method of operating a base station;

FIG. 12 is a flowchart illustrating another method of operating a wireless device;

FIG. 13 is a flowchart illustrating another method of operating a base station;

FIG. 14 is a flowchart illustrating yet another method of operating a base station; and

FIG. 15 is a timing diagram illustrating wireless device activity in IDLE mode for a wireless device configured with eDRX.

Corresponding numerals and symbols in the different figures generally refer to corresponding parts unless otherwise indicated, and may not be redescribed in the interest of brevity after the first instance. The FIGS. are drawn to illustrate the relevant aspects of exemplary embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

To provide additional context to the present disclosure, it is noted that a 3GPP Release 16 work item on MTC enhancements has as an objective to improve UL transmission efficiency and/or UE power consumption by specifying support for transmission in preconfigured resources (both shared resources and dedicated resources) in idle and/or connected mode based on SC-FDMA waveform for UEs with a valid timing advance. RAN1 work has commenced to realize this objective. Certain observations and proposals related to this objective were submitted in a contribution to 3GPP and are discussed below.

RAN1 has discussed and reached some agreements as informed to RAN4 in the LS with 3GPP document R1-1813778. The relevant MTC agreements are:

1) In idle mode, at least the following TA validation attributes are supported:
Serving cell changes (serving cell refers the cell that the UE is camping on)
Time Alignment Timer for idle mode
Serving cell RSRP changes (serving cell refers the cell that the UE is camping on)
   Based on RSRP measurement definition in existing Rel-15 TS36.214.

2) The UE can be configured to use at least these TA validation attributes:
Time Alignment Timer for idle mode
Serving cell RSRP changes
Note: the configuration shall support disabling of the TA validation attributes

The RRM impact of these TA validation attributes are discussed below.

### DISCUSSION

### A. Background

The transmission in IDLE mode using preconfigured uplink resources is realized once a UE has obtained from CONNECTED mode a timing advance (TA) command, which will later be used in IDLE mode for adjusting the timing in the uplink transmission. However, the uplink transmission using PUR in IDLE mode may not take place immediately and can occur later in time. The consequence of this behaviour is that the received TA may not be valid any longer, for example due to UE mobility, change of surrounding environment, UE timing drift etc. To solve this problem, RAN1 has identified three different TA validation attributes that are used by the UE to validate the received timing advance (TA) command in CONNECTED state prior to PUR transmission (see 3GPP document R1-1813778):
Serving cell changes (serving cell refers the cell that the UE is camping on)
Time Alignment Timer for idle mode
Serving cell RSRP changes (serving cell refers the cell that the UE is camping on)
   Based on RSRP measurement definition in existing Rel-15 TS36.214

The second and third attributes are configurable by the network, and their RRM aspects are discussed in section below.

### B. Discussions

Serving Cell Changes

The first attribute is related to change of serving cell, i.e. the received TA is considered invalid when the serving cell changes. It is an obvious attribute and should be considered when defining the RRM requirements in TS 36.133.
Proposal #1: Define RRM requirements for PUR based on serving cell change as one of the TA validation attributes.

Time Alignment Timer for IDLE Mode

The second attribute is related to time alignment timer in IDLE mode. The MTC UE can be configured with either DRX or eDRX in IDLE mode. When not configured with eDRX, the UE is required to measure RSRP and RSRQ level of the serving cell and evaluate the cell selection criterion at least once every DRX cycle. A UE configured with eDRX, on the other hand, is required to measure and evaluate the cell selection criterion at least once very PTW.

Under DRX operation, the UE receiver frequency and timing can drift and the exact drift depends on the DRX cycle length. Generally, the drift increases with DRX cycle lengths as the receiver is switched off for longer duration. The drift induces error in UE timing wrt the serving cell. For MTC wake-up signal simulations, the following frequency- and timing drifts with respect to DRX cycles (listed in Table 1 from R4-1816334, below) were assumed:

TABLE 1

| DRX cycle (s) | Frequency drift [Hz] | Timing drift [us] |
|---|---|---|
| 0.32 | 65.2 | 4.69006 |
| 0.64 | 100.4 | 4.69774 |
| 1.28 | 170.8 | 4.72846 |
| 2.56 | 311.6 | 4.85134 |

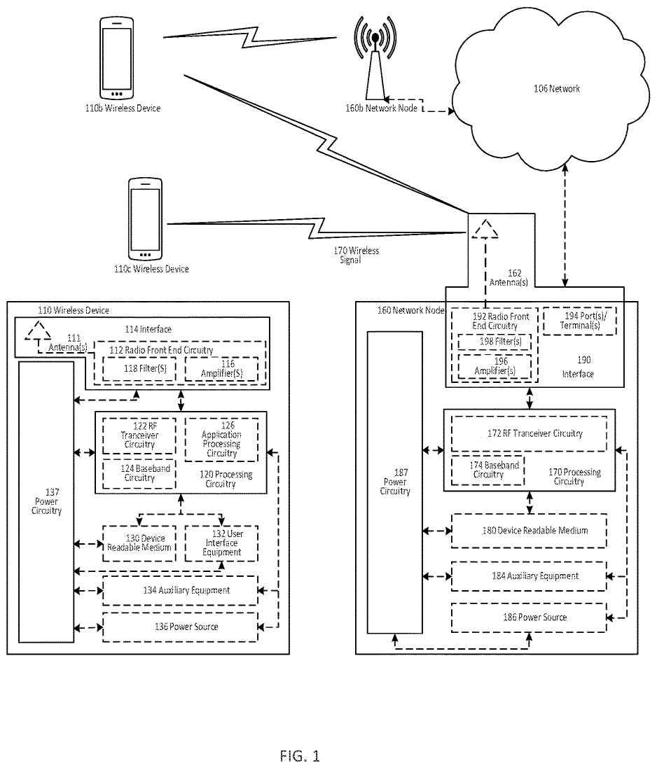

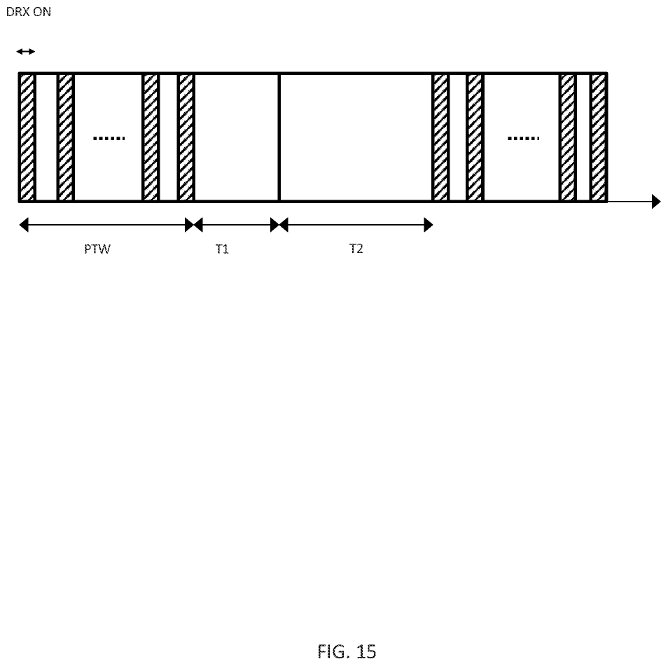

A UE configured with eDRX is required to wake up and perform RRM measurements during DRX ON durations within the PTW window. UE typically switches its receiver chain off between two PTWs to save power, and this duration can be quite long. UE activity in IDLE mode is illustrated in FIG. 15, where the time between two PTWs is split into two sub-durations, T1 and T2. The UE can still maintain the synchronization accuracy to an acceptable level for a certain duration (denoted as T1 in FIG. 1) after active period (e.g. DRX ON duration when it is configured with a certain DRX cycle, and thereafter (denoted as T2 in FIG. 1) the synchronization accuracy becomes too poor to carry out reliable transmissions. Therefore, no PUR transmission should be allowed during T2 window and the originally planned transmission can be either suspended, delayed or released. The exact length of T1 and T2 may further depend on DRX cycle configuration used by the UE in the transmitted cell. The motivation for not carrying out the PUR transmissions during time period T2 is that if UE is not well synchronized wrt the serving cell, then the UE PUR transmissions are very likely to fail especially if they arrive at the serving BS outside the CP length. Therefore, such transmissions should be avoided as they can cause unwanted interference in the network, and they will also waste the radio resources. The values of T1 and T2 depends on the configured DRX cycle, but it may also depend on UE's ability to maintain a certain synchronization accuracy. The exact values can be discussed, and determined based on company's proposals. Likewise, no PUR resources should be configured or requested for transmission during this period.
Observation #1: The UE can be out of synchronization between two PTWs, and during this time PUR transmissions are unreliable.
Proposal #3: PUR transmission should not be allowed during time period T2 where UE is not in synchronization towards the transmitted cell.
Proposal #3: No PUR resources should be configured or requested for transmission during time period T2 where UE is not in synchronization towards the transmitted cell.

Serving Cell RSRP Changes

The third attribute is related to serving cell RSRP changes. It is important to note that the measured RSRP value can vary for different reasons, and variation is not always associated with UE mobility. According to the free space path loss (FSPL) calculation formula in (1) there is a 6 dB variation in path loss when the distance between the transmitting eNodeB and the UE is doubled in the cell.

$$FSPL = 20 {log}_{10} ( d ) + 20 {log}_{10} ( f ) + 20 {log}_{10} ( \frac{4 π}{c} ) - {G}_{TX} - {G}_{RX} \qquad ( 1 )$$

This is exemplified in Table 2, where the same change (6 dB) in the path loss in all four cases corresponds to different values of TA change which is used by the UE when transmitting signals and it ensures that transmissions by all the UEs within the cell can arrive at the base station at the same time or at least within certain time e.g. within the cyclic prefix. The TA value hence is related to propagation delay and therefore to the distance between the UE and the eNodeB.

TABLE 2
: Relation between the change in path loss and change in TA

| | UE original | UE new | | | |
|---|---|---|---|---|---|
| Case | distance | distance | TA change | Path loss | RSPR |
| # | to BS | to BS | (μs) | change | error |
| 1 | 100 m | 200 m | 0.67 | 6 dB | +/− 6 dB |
| 2 | 200 m | 400 m | 1.33 | 6 dB | +/− 6 dB |
| 3 | 400 m | 800 m | 2.67 | 6 dB | +/− 6 dB |
| 4 | 800 | 1600 | 5.34 | 6 dB | +/− 6 dB |

In particular, Table 2 shows a relation between the change in path loss and change in TA and shows that the use of signal strength change method (e.g. RSRP which is linear function of PL in log scale) to check the validity of the timing advance can lead to incorrect decision. For example, in case #4 in Table 2, the change in RSRP is still within 6 dB like in other cases and would imply that the TA is still valid for UL transmission. However as shown in Table 2, the change in the TA is 5.34 μs, which is well above the normal CP length (e.g. 4.7 μs). If the UE transmits using the received TA then the eNodeB won't be able to receive the signals and will also degrade the reception of signals from other UEs.
Observation #2: There is a non-linear relation between RSRP changes and TA changes.

For a UE which needs to validate the preconfigured TA value when the PUR transmission opportunity arrives, firstly the UE needs to determine the magnitude of the serving cell RSRP change (e.g. Δ_{RSRP}) wrt reference value (i.e. measured RSRP value at time TA was received) and ensure that transmissions take place only when the magnitude of change is less than a certain threshold, i.e. Δ_{RSRP}≤Δ_{max-RSRP}. When determining the Δ_{max-RSRP}, its relation to TA value change should be taken into account since RSRP value is affected by the pathloss between the eNodeB and UE. One simple approach to determine the Δ_{max-RSRP} is based on a maximum allowed TA change (ΔTAₘₐₓ). The maximum allowed TA change (ΔTAₘₐₓ) should be set to ½*CP, this allows all transmitted UE signals to be arrived within ½*CP window. The UE is allowed to carry out the PUR transmission only if the change in the magnitude of the serving cell RSRP (Δ_{RSRP}) is less than Δ_{max-RSRP} and the TA change is less than ΔTAₘₐₓ.

For example, after obtaining the initial TA, it is possible for the UE to move +/−4.7/2*300=+/−705 m towards or away from the eNodeB until the signal falls outside the ½ CP window. This results in a certain RSRP variation depending on the original position of the UE. If the TA value is 3 us, then the distance to eNodeB becomes 3*300=900 meter, and the allowed RSRP variation becomes 20 log ((900+705)/900)=+/−5 dB. In another example, if the TA value is 1 us, the distance to eNodeB becomes 300 meter, and this results in an allowed RSRP variation of 20 log(300+705)/300)=+/10 dB.
Observation #3: The allowed RSRP variation (&ma-RSRP) decreases with increased distance to the base station.
Proposal #4: PUR transmissions are allowed only when maximum serving cell RSRP change is less than Δ_{RSRP} and received TA is less than ΔTAₘₐₓ.

### CONCLUSION

This contribution has discussed RRM impact for transmission using preconfigured uplink resources based on the received LS in R1-1813778. The three different attributes that were listed in the LS as means for validating the TA have been analyzed, and the following observations and proposals have been made:
Observation #1: The UE can be out of synchronization between two PTWs, and during this time PUR transmissions are not possible.
Proposal #1: Define RRM requirements for PUR based on serving cell change as one of the TA validation attributes.
Proposal #2: Time alignment timer value should be set taking into account the frequency and timing drifts of configured DRX cycle of the UE.
Proposal #3: No PUR resource should be configured during the time UE is out of synchronization between two PTWs.
Proposal #4: PUR transmissions are allowed only when maximum serving cell change is less than Δ_{RSRP} and received TA is less than ΔTAₘₐₓ.

Applicable Scenario

A UE served by a first cell (cell1), which in turn is managed by a first network node (NW1) may be preconfigured by NW1 with one or more radio uplink resources (e.g. resource blocks etc) based on, e.g., a request from the UE. Alternatively, the network node may preconfigure the one or more radio uplink resources without any request by the UE but instead based on some observed data (e.g., a traffic pattern). The UE also receives a timing advance value (TA) when in RRC_CONNECTED state which is later applied for a transmission based on or using the preconfigured uplink resources (PUR). The resources and the TA can be preconfigured in the RRC connected state, e.g. before the UE enters in low activity state.

The preconfigured resources and the received TA value enable the UE to transmit signals in a low activity state (e.g. in RRC idle state, RRC inactive state) when the UE has signals for uplink transmission provided that one or more conditions or criteria are met by the UE. Examples of such conditions are:
The difference between the magnitudes of the signal level (e.g. RSRP) at the UE with respect to the measured cell from which the TA value is received and a reference signal level is not larger than certain margin or threshold,
UE has not made any cell change with respect to the cell from which TA is received, examples of cell change are cell reselection handover, RRC re-establishment etc.

The reference signal level may correspond a signal level at certain time instance e.g. when the UE was preconfigured with the resources and/or TA value. When the above conditions are met the UE assumes that the preconfigured TA value is valid for uplink transmission using the preconfigured resources. However as described below, the same magnitude change in the signal level does not always guarantee the validity of the preconfigured TA value.

Due to the potential UE location change, when the UE makes the PUR transmission with preconfigured TA, the UE signal will not arrive at the BS FFT receiving window at the predefined position, e.g in the middle of CP, in such a case, it will arrive to a BS FFT receiving window sooner or later depending how far the UE has been moved from the position where the preconfigured TA was received to the new position where the PUR transmission is done. The effective TA value as perceived at the BS for this UE may be defined as being related the sum of a preconfigured TA value and a TA value change caused by the location change, which is the change of distance between the BS and UE.

According to the free space path loss (FSPL) calculation formula in equation (1) below, there is 6 dB variation in path loss when the distance between the serving BS and the UE is doubled in cell1.

$$FSPL = 20 {log}_{10} ( d ) + 20 {log}_{10} ( f ) + 20 {log}_{10} ( \frac{4 π}{c} ) - {G}_{TX} - {G}_{RX} \qquad ( 2 )$$

where:
d=distance between UE and BS (potentially dynamic in the given scenario),
f=frequency of signals transmitted by the BS to the UE (constant in the given scenario),
c=speed of light (constant in the given scenario),
GTX=antenna gain at the BS transmit antenna (constant in the given scenario),
GRX=antenna gain at the UE receive antenna (constant in the given scenario).

Table 3 illustrates a relation between the change in FSPL and change in TA. As shown in Table 3, the same change (6 dB) in the FSPL in all four cases corresponds to different values of TA change. This means the use of signal strength (e.g. RSRP which is linear function of PL in log scale) to check the validity of the timing advance leads to a wrong decision. For example, in case #4 in Table 3, the change in RSRP or PL is still within 6 dB like in other cases and would imply that the TA is still valid for UL transmission. However, as shown in Table 3, the change in the TA is 5.34 μs, which is well above the normal CP length (e.g. 4.7 μs). If the UE transmits using the preconfigured TA then the serving BS in cell1 will not be able to receive the signals and will also degrade the reception of signals from other UEs.

TABLE 3

| | UE original | UE new | | | |
|---|---|---|---|---|---|
| | distance to | distance to | TA change | Path loss | RSPR |
| Case # | BS | BS | (μs) | change | error |
| 1 | 100 m | 200 m | 0.67 | 6 dB | +/− 7 dB |
| 2 | 200 m | 400 m | 1.33 | 6 dB | +/− 7 dB |
| 3 | 400 m | 800 m | 2.67 | 6 dB | +/− 7 dB |
| 4 | 800 | 1600 | 5.34 | 6 dB | +/− 7 dB |

A method of validating the time advance by using RSRP will be needed so the erroneous decision by the UE can be avoided. By doing so, the interference generated by UE with invalid TA assumption using the PUR feature can be reduced.

According to a first aspect of a first embodiment, the UE determines a parameter related to the maximum allowed variation in signal strength (ΔSSₘₐₓ) based on the configured TA value for transmitting preconfigured UL resources in cell1. Examples of ΔSSₘₐₓ are change in RSRP (ΔRSRPₘₐₓ), change in path loss (ΔPLₘₐₓ), and the like. The determination of ΔSSₘₐₓ can be based on a relation between at least one or more parameters related to ΔSSₘₐₓ and at least one or more parameters related to TA. The relation can be pre-defined or can be configured by the network node or it can be autonomously determined by the UE. The determined value of ΔSSₘₐₓ is used by the UE for determining whether the configured TA value is valid or not. If the change (ΔSS) in the measured signal strength (e.g. PL, RSRP, NRSRP etc) compared to reference value in cell1 by the UE cell1 is within ΔSSₘₐₓ then the UE assumes that the configured TA is valid. Otherwise the UE assumes that the configured TA is not valid. If the TA is valid then the UE can transmit using UL preconfigured resources in cell1 using the valid TA. If the TA is not determined to be valid then the UE does not transmit any signal using UL preconfigured resources in cell1. The relation between ΔSS_{Max} and TA parameter is described below.

Table 4 shows an example of four different cases of TA values which can be configured by cell1 at the UE and how each maps to a maximum allowed variation in TA. Although four specific TA values are listed, the explanation below applies to other TA values.

TABLE 4

| | Distance between | Configured | Max allowed | Distance between |
|---|---|---|---|---|
| | BS and UE for | TA value | TA change | BS and UE at |
| Case | configured TA | (TA) | (\|ΔTAₘₐₓ\|) | TA + ΔTAₘₐₓ |
| 1 | 100 m | 0.67 μs | 2.35 μs | 100 +/− 700 m |
| 2 | 200 m | 1.33 μs | 2.35 μs | 200 +/− 700 m |
| 3 | 400 m | 2.03 μs | 2.35 μs | 400 +/− 700 m |
| 4 | 700 m | 4.7 μs | 2.35 μs | 700 +/− 700 m |

Assuming that the BS can receive signals from the UE within the CP length, e.g. normal CP length of 4.7 μs. The received TA value corresponds to a certain distance between the UE and BS serving cell1. Therefore, depending on the TA value, the distance between the UE and BS can be estimated. For example, when the configured TA is 0.67 μs then the UE is expected to be around 100 m from the BS. In this case the UE can transmit using the PUR resources provided that the effective change in TA does not exceed 2.35 μs with respect to the configured TA value of 0.67 μs. As shown in Table 4 this is possible for case 1, provided that the UE has not moved by more than 700 m from the BS. The maximum allowed change in the TA value (ΔTAₘₐₓ) is interchangeably called herein as TA tolerance or a maximum allowed TA variation. The TA tolerance is further used for determining the ΔSSₘₐₓ. For example, each value of TA tolerance and the configured TA value corresponds to a certain value of ΔSSₘₐₓ. The UE is configured with TA and it can determine the corresponding TA tolerance based on one or more of the following mechanisms:
relation between the TA value and TA tolerance (ΔTAₘₐₓ), which can be pre-defined or configured,
relation between the TA value and TA reference (TA_{ref}). For example, the TA tolerance (ΔTAₘₐₓ)=TA_{ref}-TA. The TA_{ref} can be pre-defined or configured by the BS (e.g. 4.7 μs, correspond to CP length, correspond to the cell size such as cell radius etc).

The upper limit of the maximum effective TA change for receiving signals from the UE at the BS receiver is limited to the CP length. Therefore, the larger the configured value of the TA the smaller is the TA change that the UE can handle. An example of TA change is assumed to be the % of CP length of signals used for communication between the BS and the UE is expressed by equations (2) and (3):

½*CP length≥|effective TA−Preconfigured TA| (2)

This would mean the maximum allowed TA change in UE can be:

TA allowed change≤½*CP length (3)

For the UE which needs to validate the preconfigure TA value when the PUR transmission opportunity arrives, firstly the UE needs to determine the magnitude of the change in the signal strength (ΔSS) with respect to reference value in cell1 and compared it with the ΔSSₘₐₓ. The ΔSS (e.g. magnitude change in RSRP) can be the magnitude of the difference between the RSRP measured before transmitting using the PUR and the RSRP measured when the UE received the TA value from the BS for cell1. The ΔSSₘₐₓ can be determined by the UE using different mapping or relations.

For example, ΔSSₘₐₓ may be determined by the UE based on a relation between the configured TA value and the ΔSSₘₐₓ. An example of this relation is shown in Table 5. In this case the relation is based on a certain maximum value of TA, e.g. corresponding to the normal CP, maximum cell radius.

TABLE 5

| | Configured | | max allowed TA | RSRP variation | |
|---|---|---|---|---|---|
| Case | TA value (TA) | | change (\|ΔTAₘₐₓ\|) | maximum (ΔRSRPₘₐₓ) | |
| 1 | 0.67 | μs | 2.35 μs | 18 | dB |
| 2 | 1.33 | μs | 2.35 μs | 13 | dB |
| 3 | 2.03 | μs | 2.35 μs | 8.8 | dB |
| 4 | 4.7 | μs | 2.35 us | 6 | dB |

In another example, ΔSSₘₐₓ is determined by the UE based on a relation between the configured TA value, TA tolerance and the ΔSSₘₐₓ as shown in the example in Table 6. In this case the TA tolerance is based on a certain maximum value of TA e.g. corresponding to the normal CP, maximum cell radius, configured value. In this example the UE can be configured with both TA and a TA reference (i.e., max allowed TA value in cell1), or with TA tolerance. Then the relation between TA and TA tolerance enables the UE to estimate or determine the ΔSSₘₐₓ based on their relations.

TABLE 6

| | Configured | | TA tolerance | RSRP variation | |
|---|---|---|---|---|---|
| Case | TA value (TA) | | (ΔTAₘₐₓ) | maximum (ΔRSRPₘₐₓ) | |
| 1 | 0.67 | μs | 2.35 μs | 18 | dB |
| 2 | 1.33 | μs | 2.35 μs | 13 | dB |
| 3 | 2.03 | μs | 2.35 μs | 8.8 | dB |
| 4 | 4.7 | μs | 2.35 us | 6 | dB |

For example, based on the relation between the TA and the maximum allowed RSRP variation, if the UE is configured with TA value of 3 μs then the UE should determine the maximum allowed RSRP variation threshold it should use to validate the TA before it does PUR transmission in cell1. In this case, due to the TA tolerance being ½*CP period the allowed TA change at UE side will be ½4.7 μs=2.35 us This corresponds to the distance change of the 2.35×300=+/−700 m, the original distance to BS is 3/2×300=450 m. This allows the UE to change distance from 450 m up to 1150 m (700+450) m, which corresponds to maximum RSRP variation (ΔRSRPₘₐₓ) of 20*log(11501450)=8.14 dB according to (1). For example, if the magnitude of the difference between the measured RSRP and reference RSRP (Δ_{RSRP}) is not larger than 8.14 dB in this example, then the UE can transmit signals using PUR in cell1.

According to another aspect of this embodiment the maximum RSRP variation (ΔRSRP_{max,real}) also takes into account the measurement accuracy of RSRP (Δ_{accuracy}). The RSRP measurement accuracy (Δ_{accuracy}) may refer to either an allowed measurement accuracy (or allowed maximum measurement error) or a real measurement accuracy, i.e., a measurement error that is achievable by the UE depending on SNR and/or a particular measurement method, among other things. For example the ΔRSRP_{max,real} is a function of ΔRSRPₘₐₓ based on FSPL model (e.g. equation (1)) and RSRP measurement accuracy (Δ_{accuracy}). An example of expression is shown in equation (4):

ΔRSRP_{max,real}≥ΔRSRPₘₐₓ+|Δ_{accuracy}| (4)

An example value for Δ_{accuracy} is 2 dB, 3 dB etc.

Examples of the corresponding mappings between TA and maximum allowed RSRP variations for determining the ΔRSRP_{max,real} are shown in Tables 7 and 8, where the maximum allowed RSRP variation takes into account the RSRP accuracy. From these examples the UE determines the ΔRSRP_{max,real}, and compares the change in the measured RSRP with respect to the reference RSRP with ΔRSRP_{max,real} for determining the validity of the TA command for transmitting UL signals using PUR.

TABLE 7

| | Configured | | max allowed TA | RSRP variation |
|---|---|---|---|---|
| Case | TA value (TA) | | change (ΔTAₘₐₓ) | maximum (ΔRSRP_{max, real}) |
| 1 | 0.67 | μs | 2.35 μs | 18 dB + Δ_{accuracy} |
| 2 | 1.33 | μs | 2.35 μs | 13 dB + Δ_{accuracy} |
| 3 | 2.03 | μs | 2.35 μs | 8.8 dB + Δ_{accuracy} |
| 4 | 4.7 | μs | 2.35 us | 6 dB + Δ_{accuracy} |

TABLE 8

| | Configured | | max allowed TA | RSRP variation |
|---|---|---|---|---|
| Case | TA value (TA) | | change (ΔTAₘₐₓ) | maximum (ΔRSRP_{max, real}) |
| 1 | 0.67 | μs | 2.35 μs | 18 dB + Δ_{accuracy} |
| 2 | 1.33 | μs | 2.35 μs | 13 dB + Δ_{accuracy} |
| 3 | 2.03 | μs | 2.35 μs | 8 dB + Δ_{accuracy} |
| 4 | 4.7 | μs | 2.35 us | 6 dB + Δ_{accuracy} |

Although the subject matter described herein may be implemented in any appropriate type of system using any suitable components, the embodiments disclosed herein are described in relation to a wireless network, such as the example wireless network illustrated in FIG. 1. For simplicity, the wireless network of FIG. 1 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards: and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node (alternately referred to as base station) refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes or base stations include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 1, network node 160 includes processing circuitry 170, device readable medium 180, interface 190, auxiliary equipment 184, power source 186, power circuitry 187, and antenna 162. Although network node 160 illustrated in the example wireless network of FIG. 1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 1 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

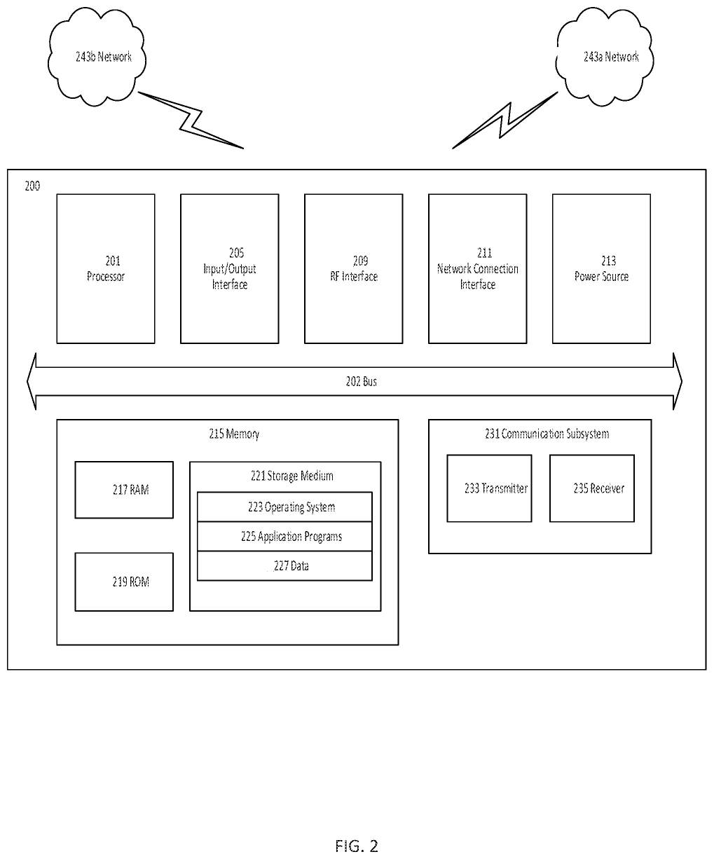

FIG. 2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 2, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 2 is a UE, the components discussed herein are equally applicable to a WD, and vice-versa.

In FIG. 2, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 2, or only a subset of the components. The level of integration between the components may vary from one UE to another UE. Further, certain UEs may contain multiple instances of a component, such as multiple processors, memories, transceivers, transmitters, receivers, etc.

In FIG. 2, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.): programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 2, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 2, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

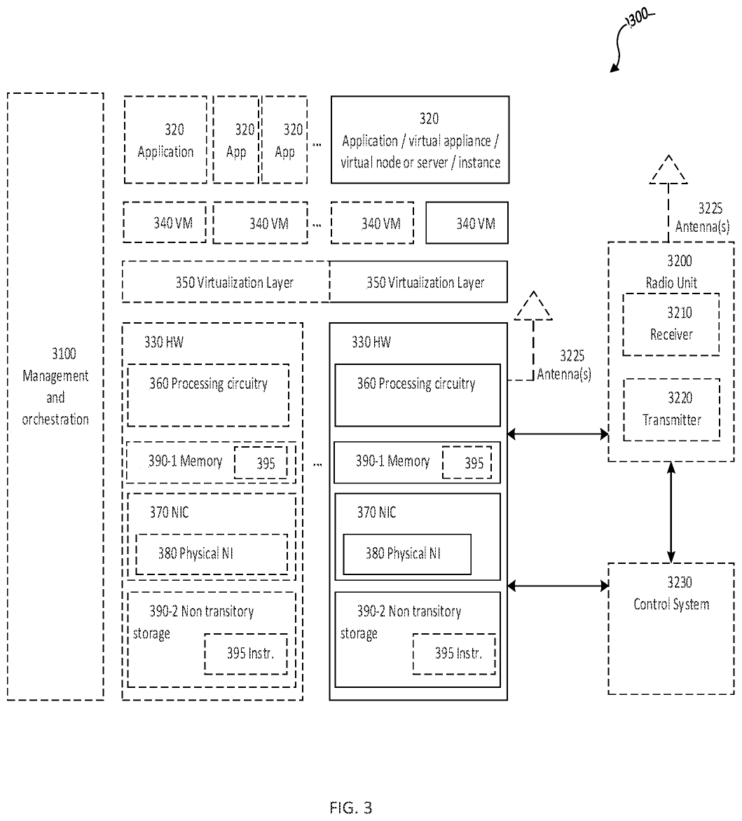

FIG. 3 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 3, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 3.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

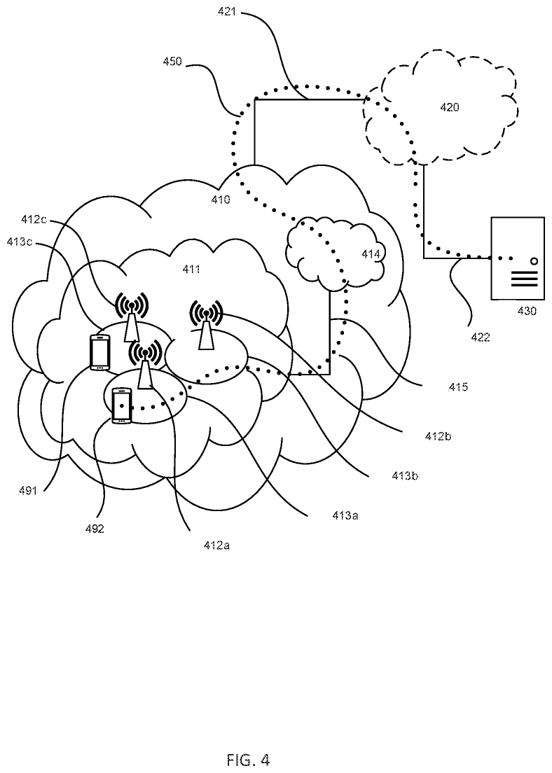

With reference to FIG. 4, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 4 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

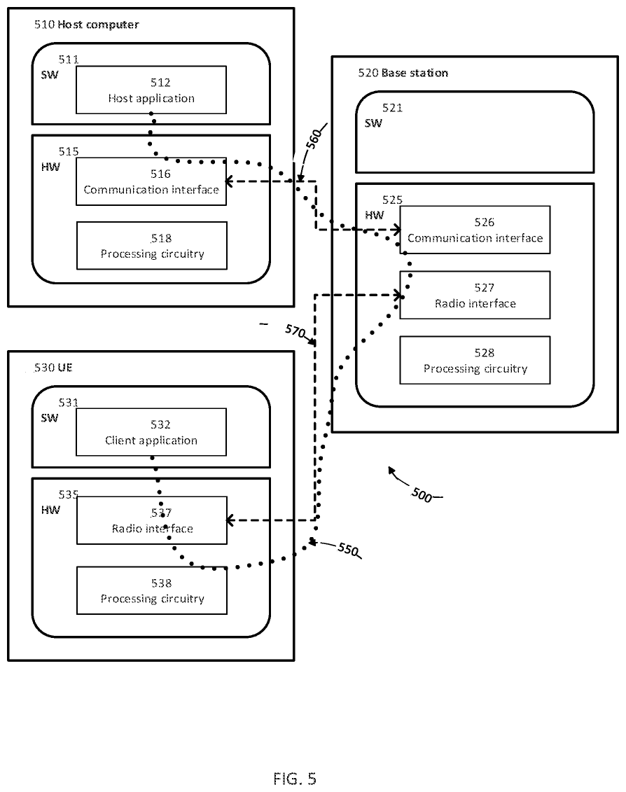

Example implementations, in accordance with an embodiment of the UE, base station and host computer discussed in the preceding paragraphs, will now be described with reference to FIG. 5. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 5) served by base station 520. Communication interface 526 may be configured to facilitate connection 560 to host computer 510. Connection 560 may be direct or it may pass through a core network (not shown in FIG. 5) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 5 may be similar or identical to host computer 430, one of base stations 412a, 412b, 412c and one of UEs 491, 492 of FIG. 4, respectively. This is to say, the inner workings of these entities may be as shown in FIG. 5 and independently, the surrounding network topology may be that of FIG. 4.

In FIG. 5, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce signaling overhead and maintain UL performance and thereby provide benefits such as extended battery life and increased network capacity.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

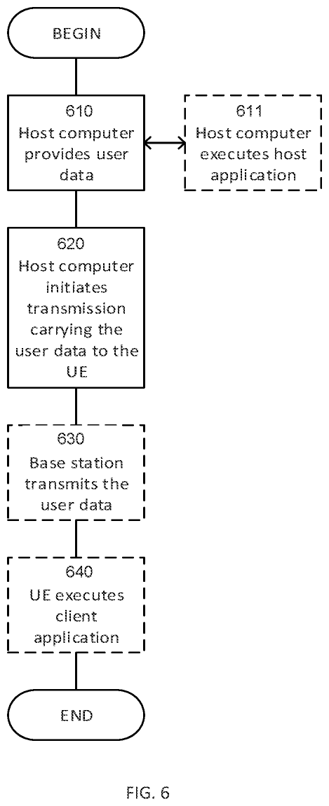

FIG. 6 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 6 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

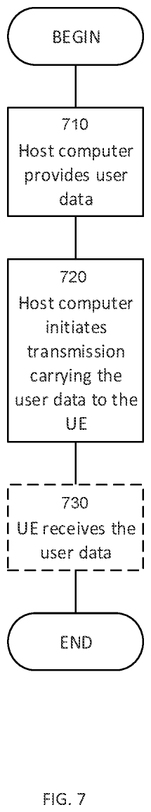

FIG. 7 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 7 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

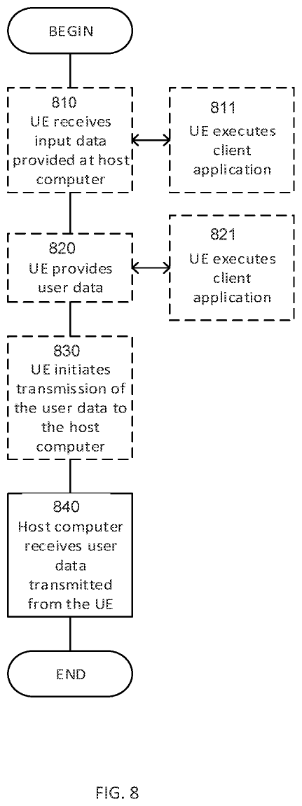

FIG. 8 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 8 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

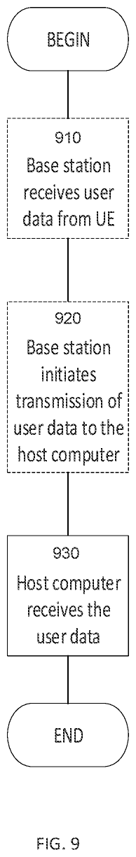

FIG. 9 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 9 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

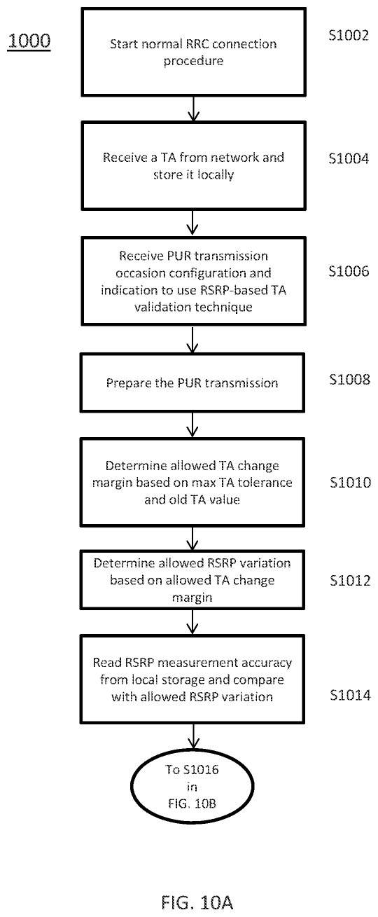

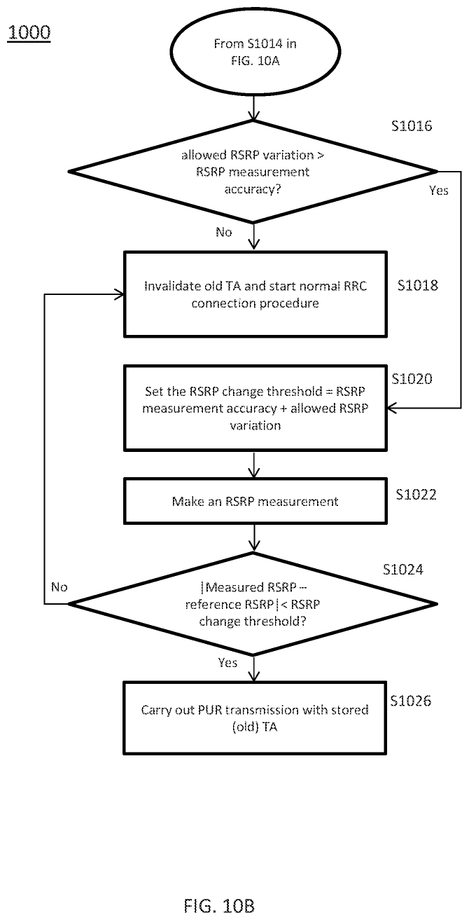

FIGS. 10A and 10B depicts a method 1000, in accordance with particular embodiments, in which a wireless device (WD) determines whether a PUR transmission is to be carried out with a stored TA. The method includes a step S1002 in which the WD starts a normal RRC connection procedure. At step S1004 the WD gets a Time Advance (TA) value from the network and stores it locally (e.g., in a local database). At step S1006, the WD is configured with PUR transmission occasions and configured by network to use an RSRP technique to validate the TA.

A period of time may elapse between the time the PUR transmission occasions are configured and the time at which the WD uses the PUR transmission occasions for a PUR transmission. During that elapsed time period the WD may have moved to a new location and the old TA value may no longer be valid. Thus, at steps S1008 and S1010 the WD prepares the PUR transmission and determines an allowed TA change margin using the old (stored) TA value and a maximum TA tolerance. Then, at step S1012 the WD determines an allowed RSRP variation (also referred to herein as a second signal strength maximum variation threshold or ΔSSₘₐₓ) based on the allowed TA margin determined at step S1010. A relation between the allowed RSRP variation and the allowed TA margin can be predefined, e.g. according to values in one or more of Tables 5-8. According to yet another aspect of this embodiment, the UE receives the relation in the form of one or more configuration parameters from the network.

At step S1014 the WD reads an RSRP measurement accuracy value (also referred to herein as a reference level) from a local memory (e.g., a database) and compares the allowed RSPR variation with the RSRP measurement accuracy value. At step S1016, the WD determines if the allowed RSRP variation is greater than the RSRP measurement accuracy value. If it is not greater (NO), the WD continues with step S1018, in which the stored TA is deemed to be invalid and the WD starts a normal RRC connection procedure. Otherwise (YES), the WD continues to step S1020.

At step S1020, the WD sets an RSRP change threshold (also referred to herein as a first signal strength maximum variation threshold) equal to the RSRP measurement accuracy value plus the allowed RSRP variation. At step S1022, the WD makes an RSRP measurement and, at step S1024, compares a measured signal strength variation (absolute value difference between the measured RSRP and an RSRP reference value) with the RSRP change threshold. If the measured signal strength variation is not less than the RSRP change threshold, the WD continues to step 1018 and deems the stored TA to be invalid. Otherwise the WD determines the stored TA to be valid and proceeds with the prepared PUR transmission based on the stored TA (step S1026).

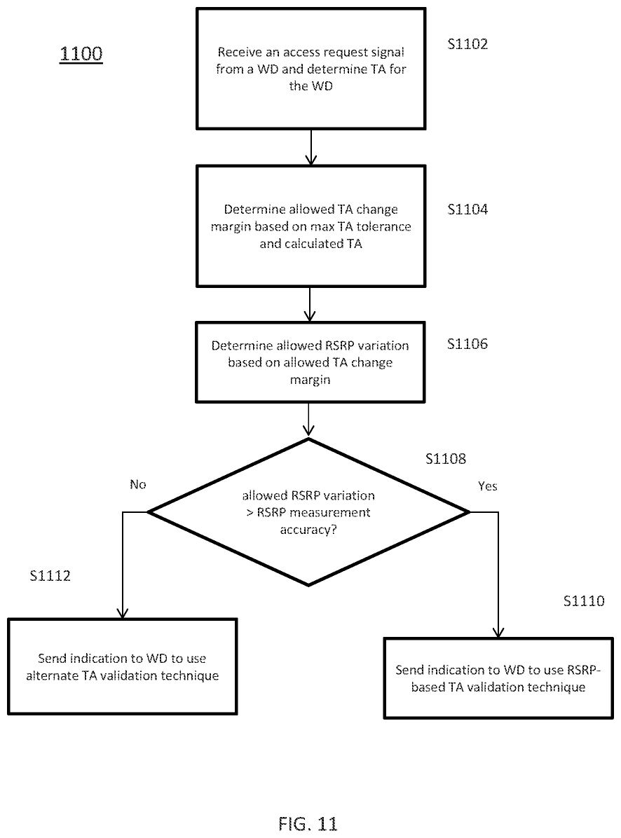

FIG. 11 depicts a method 1100, in accordance with particular embodiments, in which a base station (BS) determines whether to send an indication to a wireless device (WD) to use an RSRP-based TA validation technique. At step S1102, the BS receives an access request signal (e.g., a PRACH signal) from the WD and determines a timing advance (TA) value for the WD. At step S1104, the BS determines an allowed TA change margin using the determined TA value and a maximum TA tolerance. The maximum TA tolerance may be determined based on a CP length configured in the cell. At step S1106, the BS determines an allowed RSRP variation (e.g., ΔSSₘₐₓ) based on the allowed TA change margin. Then, at step S1108, the BS compares the allowed RSRP variation with a reference threshold level (e.g., an RSRP measurement accuracy). If, at step S1108, the allowed RSRP variation is greater than the reference threshold level, the BS sends an indication to the WD to use an RSRP-based TA validation technique, at S1110. The RSRP-based TA validation technique may include, for example, steps S1018 through S1026 in method 1000. In addition to sending the indication to use the RSRP-based TA validation technique, the BS may also send the determined TA value and the allowed RSRP variation to the WD to be used as part of the RSRP-based TA validation technique. If the allowed RSRP variation is greater than the reference threshold level, the BS may determine that the RSRP-based TA validation technique is not reliable and may send an indication to the WD to use an alternate TA validation technique at S1112. This indication may be explicit or implied, e.g., by not sending the indication to use the RSRP-based TA validation technique.

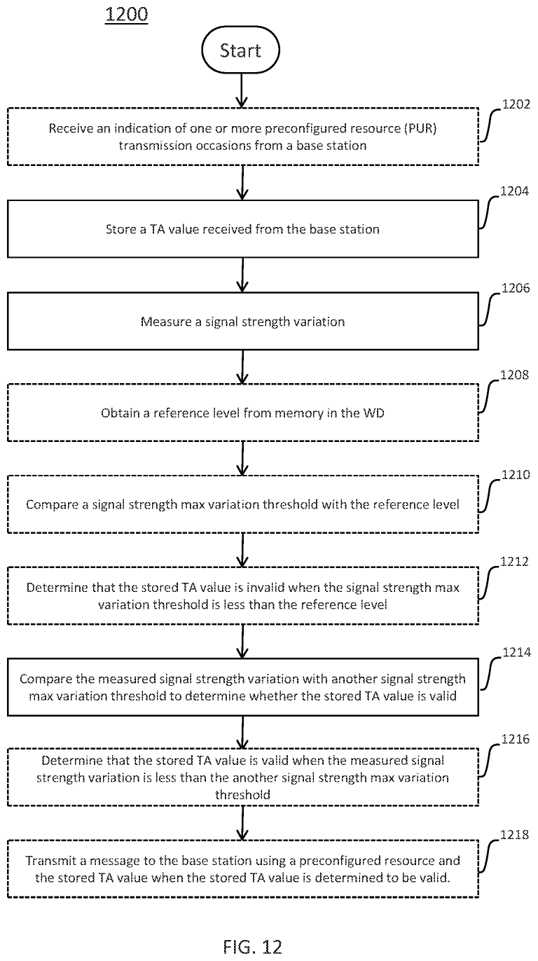

FIG. 12 depicts a method 1200 in accordance with particular embodiments. The method may be performed by a wireless device (e.g., such as the wireless device 110 or UE 200 described above). The wireless device may be a MTC-type device or an NB-IOT type device. According to one embodiment, the steps depicted with dashed line boxes are optional.

The method begins at step 1202, in which the wireless device receives an indication of one or more preconfigured resource (PUR) transmission occasions from the base station. In step 1204, the wireless device stores a TA value received from a base station. The TA value is based on a measured distance the base station and the wireless device.

In step 1206, the wireless device measures a signal strength variation. For example, in one embodiment the signal strength variation is measured by first obtaining a signal strength measurement when the stored TA value was received from the base station. Then, at a subsequent time when the wireless device has a transmission ready to transmit using a PUR, the wireless devices obtains a current signal strength measurement and calculates a difference between the current signal strength measurement and the signal strength measurement obtained when the stored TA value was received from the base station.

In step 1208, the wireless device obtains a reference level from memory in the wireless device. The reference level may be, for example 7 dB. In step 1210, the wireless device compares a signal strength maximum variation threshold (also referred to herein as a second signal strength maximum variation threshold) with the reference level and, in step 1212, determines that the stored TA value is invalid when the signal strength maximum variation threshold is less than the reference level.

In step 1214, the wireless device compares the measured signal strength variation with another signal strength maximum variation threshold (also referred to herein as a first signal strength maximum variation threshold) to determine whether the stored TA value is valid. The another signal strength maximum variation threshold varies according to the stored TA value as shown, for example, in Tables 5-8 above.

In step 1216, the wireless device determines that the stored TA value is valid when the measured signal strength variation is less than the another signal strength maximum variation threshold and, in step 1218, transmits a message to the base station using a PUR and the stored TA value.

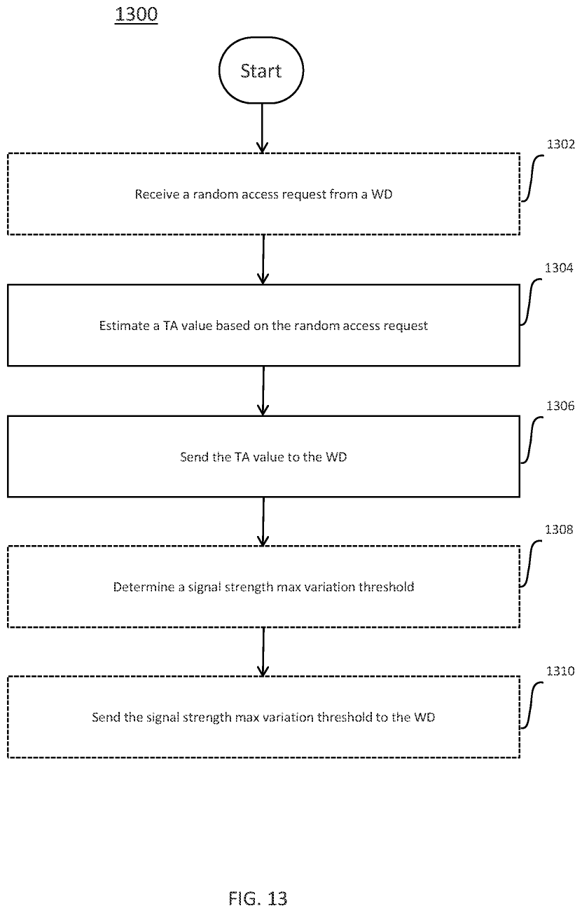

FIG. 13 depicts a method 1300 in accordance with particular embodiments. The method may be performed by a network node or base station (e.g., the network node 160 described above). According to one embodiment, the steps depicted with dashed line boxes are optional.

The method begins at step 1302, in which the base station receives a random access request from the wireless device. In step 1304, the base station estimates a TA value based on the random access request and, in step 1306, the base station sends the TA value to the wireless device.

In step 1308, the base station determines a signal strength maximum variation threshold for the wireless device to compare with a measured signal strength variation. The signal strength maximum variation threshold varies according to the TA value. The method 1300 may optionally include a step 1310 in which the signal strength maximum variation threshold is compared to a reference level and, if the signal strength maximum variation threshold is larger than (or, in some embodiments, equal to) the reference level, the base station sends the signal strength maximum variation threshold to the wireless device to facilitate a subsequent validation of the TA value by the wireless device at step 1312. The TA validation may be performed in accordance with method 1200. If the signal strength maximum variation threshold is not larger than (or, in some embodiments, equal to) the reference level, the base station does not send the signal strength maximum variation threshold to the wireless device and the wireless performs TA validation using an alternative technique (or does not perform TA validation).

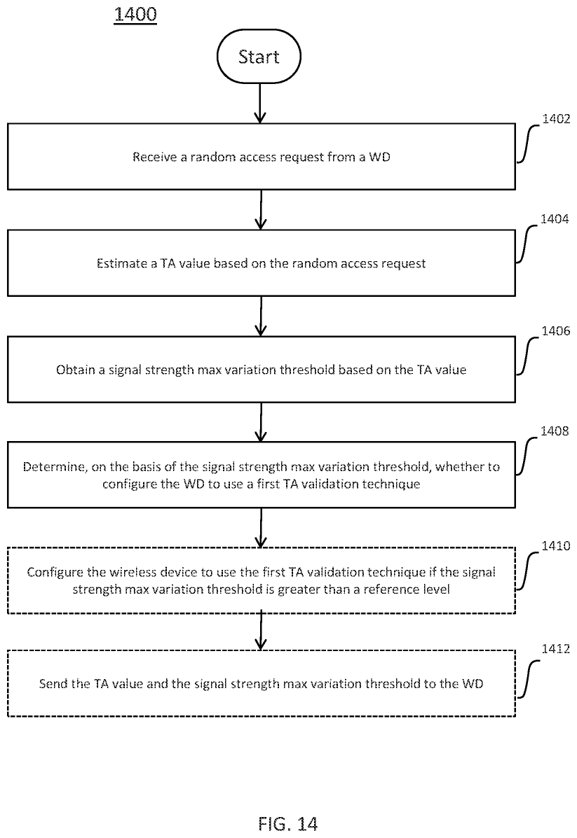

FIG. 14 depicts a method 1400 in accordance with particular embodiments. The method may be performed by a network node or base station (e.g., the network node 160 described above). According to one embodiment, the steps depicted with dashed line boxes are optional.

The method begins at step 1402, in which the base station receives random access request from the wireless device and, in step 1404, estimates a TA value based on the random access request.

In step 1406, the base station obtains a signal strength maximum variation threshold based on the TA value. In step 1408, the base station determines, on the basis of the signal strength maximum variation threshold, whether to configure the wireless device to use or carry out a TA validation technique, such as method 1200 described above or another technique that depends on signal strength measurements, to use when transmitting using the preconfigured resource.

In optional step 1410, the base station sends a message to the wireless device that configures the wireless device to use the first TA validation technique if the signal strength maximum variation threshold is greater than (or equal to, in some embodiments) a reference level. The reference level could be a predetermined value ranging, e.g., from 2-7 dB, or another value that dynamically varies based on historical statistics. If the signal strength maximum variation threshold is not greater than (or equal to, in some embodiments) the reference level, the base station may send a message to the wireless device that configures the wireless device to use or carry out a second TA validation technique that differs from the first TA validation technique. Alternatively, an instruction to use the second TA validation technique may be implied by the lack of any instruction to use the first TA validation technique.

According to one embodiment, the first TA validation technique involves the wireless device comparing a measured signal strength variation with the signal strength maximum variation threshold, which varies based on the TA value, to validate a stored TA value. The second TA validation technique, on the other hand, is a conventional TA validation technique that involves the wireless device comparing the measured signal strength variation with another signal strength maximum variation threshold that does not vary based on the TA value.

In optional step 1412, the base station sends the TA value and the signal strength maximum variation threshold to the wireless device for the wireless device to use as part of the first TA validation technique.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The disclosed subject matter should not be construed as limited to only the embodiments set forth herein; rather, these embodiments are provided by way of example to convey the scope of the subject matter to those skilled in the art.

The following are certain enumerated embodiments further illustrating various aspects the disclosed subject matter.

### Wireless Device Method Embodiments

1. A method performed by a wireless device for validating a timing advance (TA) value for use with an uplink transmission in a wireless communication network using a preconfigured resource, the method comprising:
   storing a TA value received from a base station;
   measuring a signal strength variation;
   comparing the measured signal strength variation with a first signal strength maximum variation threshold to determine whether the stored TA value is valid,
   wherein the first signal strength maximum variation threshold varies according to the stored TA value.
2. The method of embodiment 1, further comprising
   comparing a second signal strength maximum variation threshold with a reference level; and
   determining that the stored TA value is invalid when the second signal strength maximum variation threshold is less than the reference level.
3. The method of embodiment 2, wherein the first signal strength maximum variation threshold is the second signal strength maximum variation threshold plus the reference level.
4. The method of embodiment 2, further comprising:
   obtaining the reference level from memory in the wireless device.
5. The method of any one of the preceding embodiments, further comprising:
   transmitting a message to the base station using a preconfigured resource and the stored TA value when the stored TA value is determined to be valid.
6. The method of embodiment 6, wherein the wireless device is configured in an idle mode when the message is transmitted using the preconfigured resource.
7. The method of any one of the preceding embodiments, further comprising:
   determining that the stored TA value is valid when the measured signal strength variation is less than the first signal strength maximum variation threshold.
8. The method of any one of the preceding embodiments, wherein measuring the measured signal strength variation includes:
   obtaining a current signal strength measurement, and
   calculating a difference between the current signal strength measurement and a signal strength measurement obtained at a time the stored TA value was received from the base station.
9. The method of any one of the preceding embodiments further comprising:
   receiving an indication of one or more preconfigured resource transmission occasions from the base station.
10. The method of any one of the preceding embodiments, wherein a mapping defines how the first signal strength maximum variation threshold varies according to the stored TA value, wherein the mapping maps a plurality of TA values to corresponding signal strength maximum variation threshold using one or more of:
   a table,
   a function, and
   one or more conditional expressions.
11. The method of embodiment 11, wherein the mapping is one of:
   at least partially pre-defined,
   at least partially configured by the network, and/or
   at least partially determined autonomously by the wireless device.
12. The method of any one of the preceding embodiments, wherein the signal strength maximum variation threshold is an RSRP maximum variation threshold.
13. The method of any one of the preceding embodiments, wherein the first signal strength maximum variation threshold is obtained using one or more of:
   a cyclix prefix length of a configured frame structure,
   a network-configured time advance allowed error,
   the stored TA value,
   a distance between the wireless device and the base station at a time the TA value is received,
   an allowed distance change accuracy determined on the basis of the cyclic prefix length and/or the network-configured time advance allowed error,
   a network-configured allowed distance change accuracy, and
   a pathloss model to derive the signal change.
14. The method of any one of the preceding embodiments, wherein the first signal strength maximum variation threshold is configured in the wireless device by the wireless communication network.

### Base Station Method Embodiments

15. A method performed by a base station for facilitating validating a TA value for use with an uplink transmission from a wireless device using a preconfigured resource, the method comprising:
   receiving a random access request from the wireless device;
   estimating a TA value based on the random access request;
   sending the TA value to the wireless device;
   determining a signal strength maximum variation threshold for the wireless device to compare with a measured signal strength variation, wherein the signal strength maximum variation threshold varies according to the TA value.
   sending the signal strength maximum variation threshold to the wireless device to facilitate validation of the TA value by the wireless device.
16. A method performed by a base station for facilitating validating a TA value for use with an uplink transmission from a wireless device using a preconfigured resource, the method comprising:
   receiving a random access request from the wireless device;
   estimating a TA value based on the random access request;
   obtaining a signal strength maximum variation threshold based on the TA value; and
   determining, on the basis of the signal strength maximum variation threshold, whether to configure the wireless device to carry out a TA validation procedure to use when transmitting using the preconfigured resource.
17. The method of embodiment 16, further comprising:
   sending a message to the wireless device that configures the wireless device to carry out the TA validation procedure if the signal strength maximum variation threshold is greater than a reference level.
18. The method of embodiment 17, wherein the TA validation procedure is a first TA validation procedure and the method further comprises:
   sending a message to the wireless device that configures the wireless device to carry out a second TA validation procedure that differs from the first TA validation procedure if the signal strength maximum variation threshold is not greater than the reference level.
19. The method of any one of embodiments 18, wherein according to the first TA validation procedure the wireless device is configured to compare a measured signal strength variation with the signal strength maximum variation threshold and according to the second TA validation procedure the wireless device is configured to compare the measured signal strength variation with another signal strength maximum variation threshold that does not vary based on the TA value.
20. The method of any one of embodiments 16-19, further comprising:
   sending the TA value and the signal strength maximum variation threshold to the wireless device for the wireless device to use as part of the TA validation procedure.

### Apparatus Embodiments

21. A wireless device for operation in a wireless communication network, the wireless device comprising:
   processing circuitry configured to perform any of the steps of any of embodiments 1-14; and
   communication circuitry configured to transmit/receive transmissions to/from one or more radio access nodes in the wireless communication network.
22. A base station for operation in a wireless communication network, the base station comprising:
   processing circuitry configured to perform any of the steps of any of embodiments 15-20;
   communication circuitry configured to transmit/receive transmissions to/from one or more wireless devices in the wireless communication network.
23. A wireless device for operation in a wireless communication network, the wireless device being adapted to carry out the method of any of embodiments 1-14.
24. A base station for operation in a wireless communication network, the base station being adapted to carry out the method of any of embodiments 15-20.

### Additional Embodiments

25. A communication system including a host computer comprising:
   processing circuitry configured to provide user data; and
   a communication interface configured to forward user data to a cellular network for transmission to a wireless device,
   wherein the wireless device comprises a radio interface and processing circuitry, the wireless device's components configured to perform the steps of any one of embodiments 1-14.
26. The communication system of the previous embodiment, wherein the cellular network further includes a base station configured to communicate with the wireless device.
27. The communication system of either of embodiments 25 or 26, wherein:
   the processing circuitry of the host computer is configured to execute a host application, thereby providing the user data; and
   the wireless device's processing circuitry is configured to execute a client application associated with the host application.
28. A method implemented in a communication system including a host computer, a base station, and a wireless device, the method comprising:
   at the host computer, providing user data; and
   at the host computer, initiating a transmission carrying the user data to the wireless device via a cellular network comprising the base station, wherein the wireless device performs any of the steps of any of embodiments 1-14.
29. The method of embodiment 28, further comprising at the wireless device, receiving the user data from the base station.
30. A communication system including a host computer comprising:
   communication interface configured to receive user data originating from a transmission from a wireless device to a base station,
   wherein the wireless device comprises a radio interface and processing circuitry, the wireless device's processing circuitry configured to perform any of the steps of any one of embodiments 1-14.
31. The communication system of embodiment 30, further including the wireless device.
32. The communication system of any one of the previous 2 embodiments, further including the base station, wherein the base station comprises a radio interface configured to communicate with the wireless device and a communication interface configured to forward to the host computer the user data carried by a transmission from the wireless device to the base station.
33. The communication system of any one of embodiments 30-32, wherein:
   the processing circuitry of the host computer is configured to execute a host application; and
   the wireless device's processing circuitry is configured to execute a client application associated with the host application, thereby providing the user data.
34. The communication system of any one of embodiments 30-33, wherein:
   the processing circuitry of the host computer is configured to execute a host application, thereby providing request data: and
   the wireless device's processing circuitry is configured to execute a client application associated with the host application, thereby providing the user data in response to the request data.
35. A method implemented in a communication system including a host computer, a base station and a wireless device, the method comprising:
   at the host computer, receiving user data transmitted to the base station from the wireless device, wherein the wireless device performs any of the steps of any one of embodiments 1-14.
36. The method of the previous embodiment, further comprising, at the wireless device, providing the user data to the base station.
37. The method of either of embodiments 35 or 36, further comprising:
   at the wireless device, executing a client application, thereby providing the user data to be transmitted; and
   at the host computer, executing a host application associated with the client application.
38. The method of any one of embodiments 35-37, further comprising:
   at the wireless device, executing a client application; and
   at the wireless device, receiving input data to the client application, the input data being provided at the host computer by executing a host application associated with the client application,
   wherein the user data to be transmitted is provided by the client application in response to the input data.
39. A communication system including a host computer comprising a communication interface configured to receive user data originating from a transmission from a wireless device to a base station, wherein the base station comprises a radio interface and processing circuitry, the base station's processing circuitry configured to perform any of the steps of any one of embodiments 1-14.
40. The communication system of the previous embodiment further including the base station.
41. The communication system of either of embodiments 39 or 40, further including the wireless device, wherein the wireless device is configured to communicate with the base station.
42. The communication system of any one of embodiments 39-41, wherein:
   the processing circuitry of the host computer is configured to execute a host application;
   the wireless device is configured to execute a client application associated with the host application, thereby providing the user data to be received by the host computer.
43. A method implemented in a communication system including a host computer, a base station and a wireless device, the method comprising:
   at the host computer, receiving, from the base station, user data originating from a transmission which the base station has received from the wireless device, wherein the wireless device performs any of the steps of any one of embodiments 1-14.
44. The method of embodiment 43, further comprising at the base station, receiving the user data from the wireless device.
45. The method of either of embodiments 43 or 44, further comprising at the base station, initiating a transmission of the received user data to the host computer.

1. A method performed by a wireless device for validating a timing advance (TA) value for use with an uplink transmission in a wireless communication network using a preconfigured resource, the method comprising:
storing a TA value received from a base station;
measuring a signal strength variation;
comparing the measured signal strength variation with a first signal strength maximum variation threshold to determine whether the stored TA value is valid.

2. The method of claim 1, wherein the first signal strength maximum variation threshold varies according to the stored TA value.

3. The method of claim 1, further comprising:
comparing a second signal strength maximum variation threshold with a reference level; and
determining that the stored TA value is invalid when the second signal strength maximum variation threshold is less than the reference level.

4. The method of claim 3, wherein the first signal strength maximum variation threshold is the second signal strength maximum variation threshold plus the reference level.

5. The method of claim 3, further comprising:
obtaining the reference level from memory in the wireless device.

6. The method of claim 1, further comprising:
transmitting a message to the base station using a preconfigured resource and the stored TA value when the stored TA value is determined to be valid.

7. The method of claim 6, wherein the wireless device is configured in an idle mode when the message is transmitted using the preconfigured resource.

8. The method of claim 1, further comprising:
determining that the stored TA value is valid when the measured signal strength variation is less than the first signal strength maximum variation threshold.

9. The method of claim 1, wherein measuring the measured signal strength variation includes:
obtaining a current signal strength measurement, and
calculating a difference between the current signal strength measurement and a signal strength measurement obtained at a time the stored TA value was received from the base station.

10. The method of claim 1, further comprising:
receiving an indication of one or more preconfigured resource transmission occasions from the base station.

11. The method of claim 1, wherein the first signal strength maximum variation threshold varies according to the stored TA value in accordance with a mapping that associates a plurality of TA values with corresponding signal strength maximum variation thresholds using one or more of:
a table,
a function, and
one or more conditional expressions.

12. (canceled)

13. The method of claim 1, wherein the signal strength maximum variation threshold is an RSRP maximum variation threshold.

14. The method of claim 1, wherein the first signal strength maximum variation threshold is obtained using one or more of:
a cyclix prefix length of a configured frame structure,
a network-configured time advance allowed error,
the stored TA value,
a distance between the wireless device and the base station at a time the TA value is received,
an allowed distance change accuracy determined on the basis of the cyclic prefix length and/or the network-configured time advance allowed error,
a network-configured allowed distance change accuracy, and
a pathloss model to derive the signal change.

15. (canceled)

16. A method performed by a base station for facilitating validating a TA value for use with an uplink transmission from a wireless device using a preconfigured resource, the method comprising:
receiving a random access request from the wireless device;
estimating a TA value based on the random access request;
sending the TA value to the wireless device;
determining a signal strength maximum variation threshold for the wireless device to compare with a measured signal strength variation; and
sending the signal strength maximum variation threshold to the wireless device to facilitate validation of the TA value by the wireless device.

17. The method of claim 16, further comprising
comparing the signal strength maximum variation threshold to a reference level, wherein the signal strength maximum variation threshold is sent to the wireless device if the signal strength maximum variation threshold is larger than the reference level.

18. The method of claim 16, wherein the signal strength maximum variation threshold varies according to the TA value.

19. A method performed by a base station for facilitating validating a TA value for use with an uplink transmission from a wireless device using a preconfigured resource, the method comprising:
receiving a random access request from the wireless device;
estimating a TA value based on the random access request;
obtaining a signal strength maximum variation threshold based on the TA value; and
determining, on the basis of the signal strength maximum variation threshold, whether to configure the wireless device to use a TA validation technique that depends on signal strength measurements when transmitting using the preconfigured resource.

20. The method of claim 19, further comprising:
sending a message to the wireless device that configures the wireless device to use the TA validation technique if the signal strength maximum variation threshold is greater than a reference level.

21. The method of claim 19, wherein the TA validation technique is a first TA validation technique and the method further comprises:
sending a message to the wireless device that configures the wireless device to use a second TA validation technique that differs from the first TA validation technique if the signal strength maximum variation threshold is not greater than the reference level.

22. The method of claim 21, wherein according to the first TA validation technique the wireless device is configured to compare a measured signal strength variation with the signal strength maximum variation threshold and according to the second TA validation technique the wireless device is configured to compare the measured signal strength variation with another signal strength maximum variation threshold that does not vary based on the TA value.

23. The method of claim 19, further comprising:
sending the TA value and the signal strength maximum variation threshold to the wireless device for the wireless device to use as part of the TA validation technique.

24. A wireless device for operation in a wireless communication network, the wireless device comprising:
processing circuitry; and
communication circuitry configured to transmit/receive transmissions to/from one or more base stations in the wireless communication network,
wherein the processing circuitry is configured to validate a TA value for use with an uplink transmission in the wireless communication network using a preconfigured resource by:
storing a TA value received from a base station;
measuring a signal strength variation; and
comparing the measured signal strength variation with a first signal strength maximum variation threshold to determine whether the stored TA value is valid.

25. A base station for operation in a wireless communication network, the base station comprising:
processing circuitry; and
communication circuitry configured to transmit/receive transmissions to/from one or more wireless devices in the wireless communication network,
wherein the processing circuitry is configured to facilitate validation of a TA value for use with an uplink transmission from a wireless device using a preconfigured resource by:
receiving a random access request from the wireless device;
estimating a TA value based on the random access request;
obtaining a signal strength maximum variation threshold based on the TA value; and
determining, on the basis of the signal strength maximum variation threshold, whether to configure the wireless device to use a TA validation technique that depends on signal strength measurements when transmitting using the preconfigured resource.

26. (canceled)

27. (canceled)
